(19) United States
(12) Patent Application Publication
(10) Pub. No.: US 2016/0218426 A1
(43) Pub. Date: Jul. 28, 2016

(54) POWER MANAGEMENT IN WIRELESS COMMUNICATIONS DEVICES

(71) Applicant: Nitero Pty Ltd., Carlton (AU)

(72) Inventors: Pat Kelly, Austin, TX (US); Antonio Torrini, Austin, TX (US); Natalino Camilleri, Cupertino, CA (US)

(21) Appl. No.: 14/605,759

(22) Filed: Jan. 26, 2015

(51) Int. Cl. H01Q 3/24

(52) U.S. Cl. CPC H01Q 3/24

(57) ABSTRACT

An approach is provided for managing power consumption in mobile devices configured with a plurality of directional antenna elements and a radio frequency integrated circuit (RFIC). The RFIC is configured to select for use, by the mobile device, a first set of one or more directional antenna elements from the plurality of directional antenna elements based upon selection criteria that include at least one or more power consumption criteria and one or more of one or more performance criteria or one or more interference avoidance criteria.

### FIELD

The disclosed technologies relate generally to wireless communications, and more particularly, to reducing power consumption in mobile wireless communications devices.

### BACKGROUND

The availability of unlicensed millimeter wave (mm-wave) radio frequency (RF) bands is spurring the development of main stream applications that use mm-wave wireless technologies. For example, the Institute of Electrical and Electronics Engineers (IEEE) 802.11ad standard, sometimes referred to as “Wi-Gig”, specifies a data rate of up to approximately 7 Gigabits per second over the 60 GHz frequency band for consumer applications such as wireless transmission of high-definition video.

Wireless communications devices that use high frequency bands, such as the 60 GHz frequency band, often incorporate beam forming technology to achieve a desired level of range and performance. While beam forming can be very effective, implementing beam steering can require increased complexity, for example in the form of phase shifting circuitry, cost and module size. Power consumption is also increased when multiple RF paths are simultaneously active to provide beam forming.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

Embodiments are described with reference to figures in which like reference numerals refer to corresponding elements throughout the figures.

FIG. 1A depicts an example wireless communications arrangement.

FIG. 1B depicts mobile devices that include two or more antennas that are configured to allow communications in coverage areas to support communications with a base station and a mobile device.

FIG. 2A is a block diagram that depicts an example Radio Frequency Integrated Circuit (RFIC) antenna package.

FIG. 2B is a top schematic view of an example RFIC antenna package.

FIG. 2C is a bottom schematic view of an example RFIC antenna package.

FIG. 2D is a top perspective schematic view of an example RFIC antenna package.

FIG. 2E is a bottom perspective schematic view of an example RFIC antenna package.

FIG. 3A is a three-dimensional radiation pattern plot when the downward pointing patch antenna element of the example RFIC antenna package of FIG. 2A is being driven and the other antenna elements are not being driven.

FIG. 3B is a three-dimensional radiation pattern plot when the forward pointing end fire antenna element of the example RFIC antenna package of FIG. 2A is being driven and the other antenna elements are not being driven.

FIG. 3C is a three-dimensional radiation pattern plot when the upward pointing patch antenna element of the example RFIC antenna package of FIG. 2A is being driven and the other antenna elements are not being driven.

FIG. 4 is a block diagram that depicts an RFIC antenna package that includes Vivaldi end fire antenna elements and an RFIC.

FIG. 5 is a flow diagram that depicts an approach for a mobile device to select different antenna elements for use.

### DETAILED DESCRIPTION

In the following description, for the purposes of explanation, numerous specific details are set forth in order to provide a thorough understanding of various embodiments. It will be apparent, however, that embodiments may be practiced without these specific details. In other instances, well-known structures and devices are depicted in block diagram form in order to avoid unnecessarily obscuring the embodiments.

It should be understood that, although the terms first, second, etc. may be used herein to describe various elements, these elements should not be limited by these terms. These terms are only used to distinguish one element from another. For example, a first antenna element could be termed a second antenna element, and similarly, a second antenna element could be termed a first antenna element.

The terminology used in the description herein is for the purpose of describing example embodiments only and is not intended to be limiting. As used in the description of the example embodiments and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will further be understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

I. Overview

II. Architecture Overview

III. RFIC Antenna Package

IV. Antenna Selection

### I. Overview

An approach is provided for managing power consumption in mobile devices configured with a plurality of directional antenna elements and a radio frequency integrated circuit (RFIC). The RFIC is configured to select for use, by the mobile device, a first set of one or more directional antenna elements from the plurality of directional antenna elements based upon selection criteria that include at least one or more power consumption criteria and one or more of one or more performance criteria or one or more interference avoidance criteria. The approach provides sufficient range and performance to allow the mobile device to operate in high frequency bands, such as the 60 GHz frequency band, with reduced power consumption, complexity and size.

### II. Architecture Overview

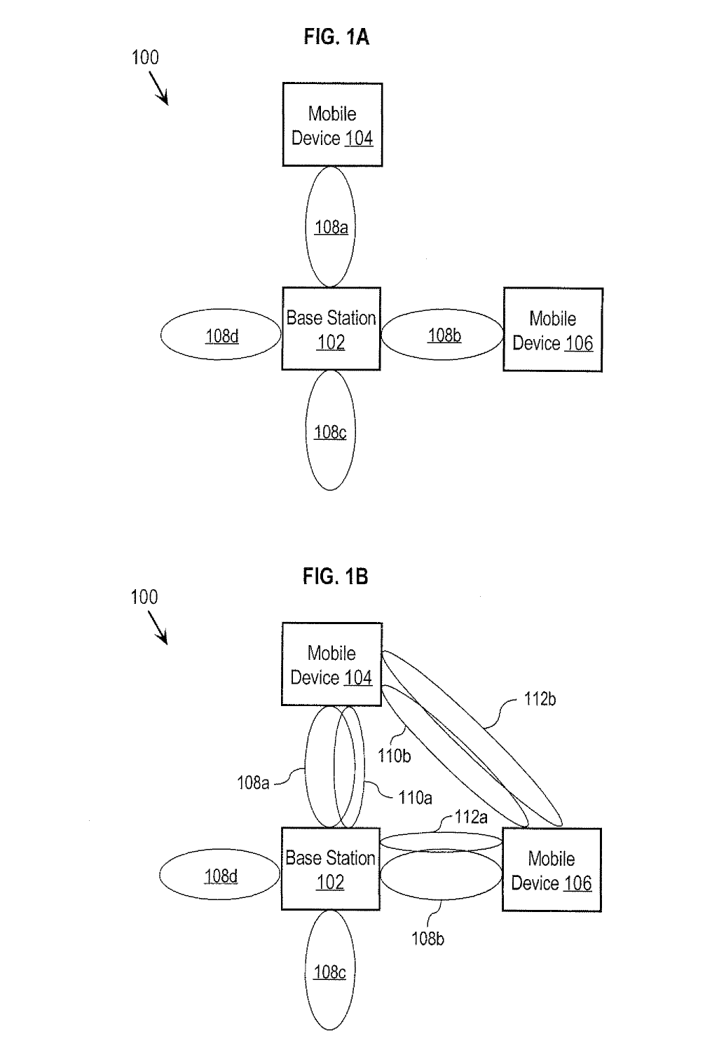

FIG. 1A depicts an example wireless communications arrangement 100 in which embodiments may be implemented. Arrangement 100 includes a base station 102 and mobile devices 104, 106. Base station 102 may be implemented as a stand-alone communications base station, or may be part of another device or system for providing wireless communications with mobile devices 104, 106. Mobile devices 104, 106 may be any type of mobile device that may vary depending upon a particular implementation. Example implementations of mobile devices 104, 106 include, without limitation, smart phones, tablet computing devices, laptop computers, personal digital assistants, etc. Although embodiments are described herein in the context of two mobile devices 104, 106 for purposes of explanation, embodiments are applicable to any number of mobile devices of the same or varying types. Base station 102 and mobile devices 104, 106 communicate with each other via one or more wireless communications links and may also communicate via one or more wired communications links that are not depicted in FIG. 1A.

Base station 102 and mobile devices 104, 106 are configured with computer hardware, computer software and/or circuitry elements to provide wireless communications. Base station 102 may be configured with various antenna elements to provide wireless communications with mobile devices 104, 106. For example, base station 102 may be configured with one or more antennas for transmitting data and one or more antennas for receiving data. The same or different antennas may be used for transmitting and receiving data, depending upon a particular implementation, and different types of antennas may be used. Example antenna types include, without limitation, patch antennas, dipole antennas, end-fire antennas, Yagi antennas, etc., or any combination thereof. As one non-limiting example, base station 102 may be configured with a first array of patch antennas for transmitting data and a second array of patch antennas for receiving data. The antennas may be located and/or oriented on base station 102 to provide wireless communications with devices located at certain locations/positions with respect to base station 102.

As depicted in FIG. 1A, base station 102 may include one or more antennas configured to allow communication in coverage areas 108a-d around base station 102, which include mobile devices 104, 106. The antennas may provide communication in any direction and/or plane. For example, assuming that the directions depicted in FIG. 1A are in an X-Y plane, base station 102 may include antennas that also or instead provide communication in a Z plane. Base station 102 may also include the capability to use multiple active RF paths and full beam forming to communicate with mobile devices 104, 106 to provide adequate range and performance. For example, base station 102 may include one or more beam forming components that include hardware components, e.g., phase shifting circuitry, etc., firmware, computer software, or any combination thereof, configured to use any number of antenna elements in an antenna array to change the directionality of the antenna array. The inclusion of beam forming capability in base station 102 generally does not present any issues with respect to size, complexity or power constraints as it does with mobile devices 104, 106.

According to one embodiment, mobile devices 104, 106 are not configured with beam forming capability because of size, complexity and power considerations and instead are configured with two or more directional antenna elements of the same or varying type and the capability to select particular directional antenna elements, e.g., one particular directional antenna element, to be used for communications. This approach allows mobile devices 104, 106 to satisfy more stringent size, complexity and power consumption constraints compared to base station 102. The directional antenna elements may provide a radiation pattern in a particular plane and/or direction with respect to mobile devices 104, 106. For example, as depicted in FIG. 1B, mobile device 104 includes two or more antennas that are configured to allow communications in coverage areas 110a, 110b, to support communications with base station 102 and mobile device 106, respectively. Similarly, mobile device 106 includes two or more antennas that are configured to allow communications in coverage areas 112a, 112b, to support communications with base station 102 and mobile device 104, respectively. The example coverage areas depicted in FIG. 1B are non-limiting examples and mobile devices 104, 106 may be configured with antenna elements to allow communications in other coverage areas, depending upon a particular implementation. The coverage areas provided by the antenna elements of a mobile device may be overlapping, partially overlapping, or non-overlapping, depending upon a particular implementation.

Mobile devices 104, 106 may include a Radio Frequency Integrated Circuit (RFIC) antenna package that includes a plurality of antenna elements and an RFIC for selecting antenna elements to be used. The antenna elements may be located on the RFIC antenna package to radiate in different directions relative to the RFIC antenna package. Alternatively, one or more antenna elements may be located external to the RFIC antenna package. Further, different types of antenna elements may be used to realize different radiation patterns. Mobile devices 104, 106 may include the same number, type and location of antenna elements, or the number, type and location of antenna elements may be different, depending upon a particular implementation. For example, in the situation where mobile devices 104, 106 are different types of devices, then mobile devices 104, 106 may have a different number, type and/or location of antenna elements. In this example, the physical structure of a mobile device may dictate the location and/or orientation of antenna elements.

### III. RFIC Antenna Package

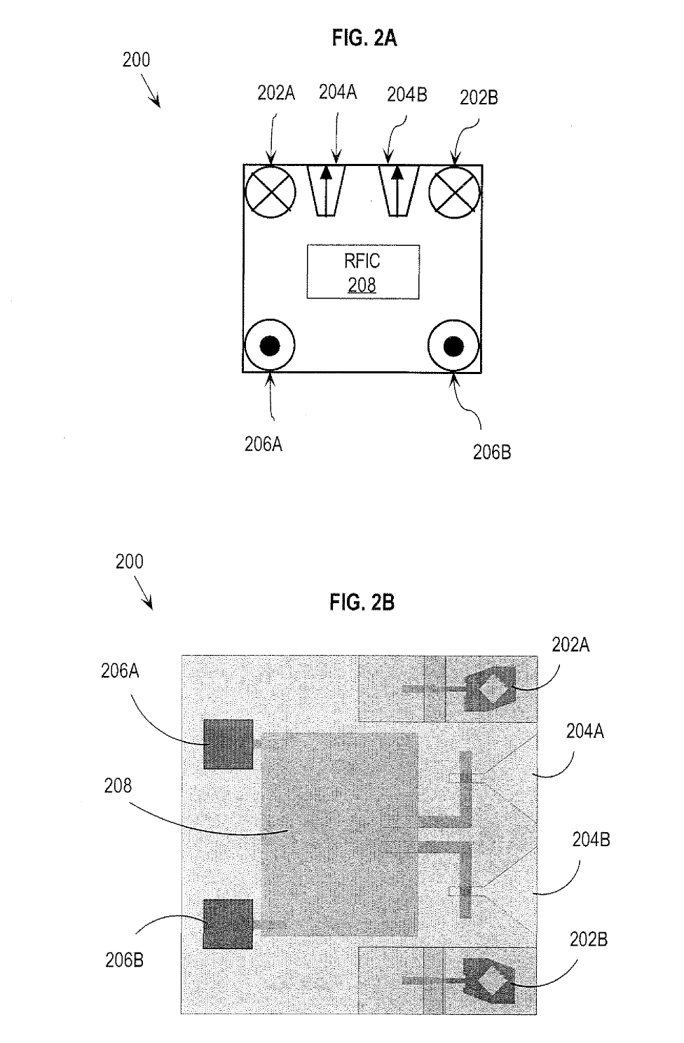

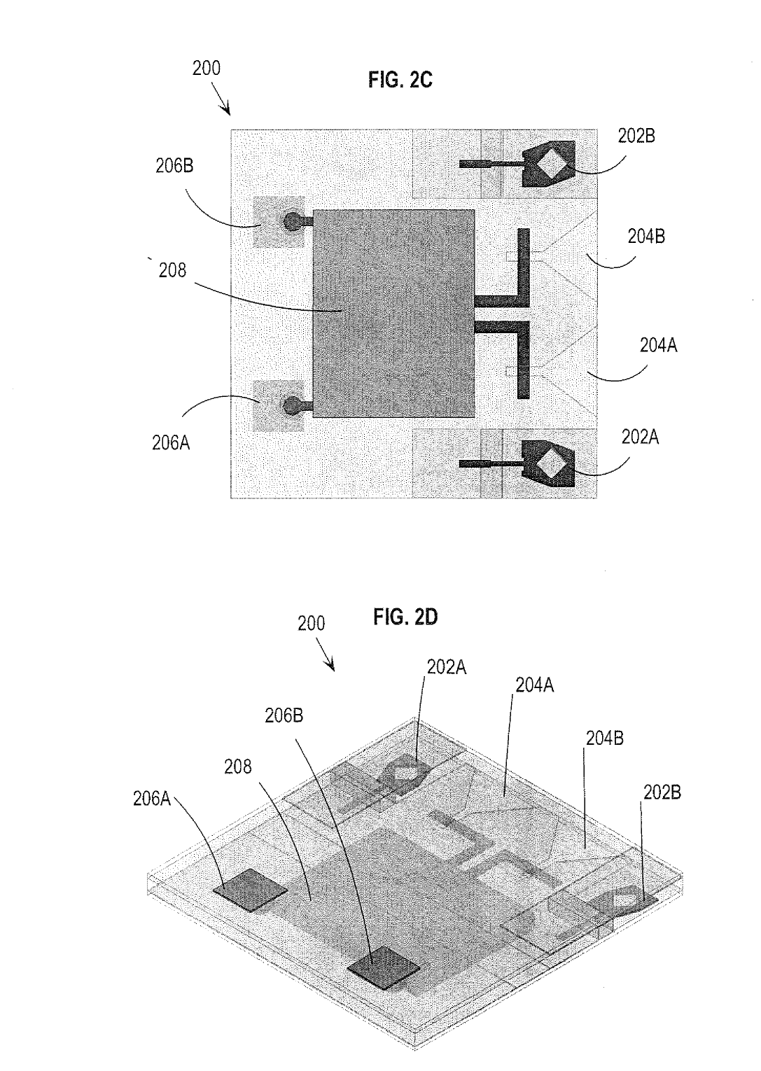

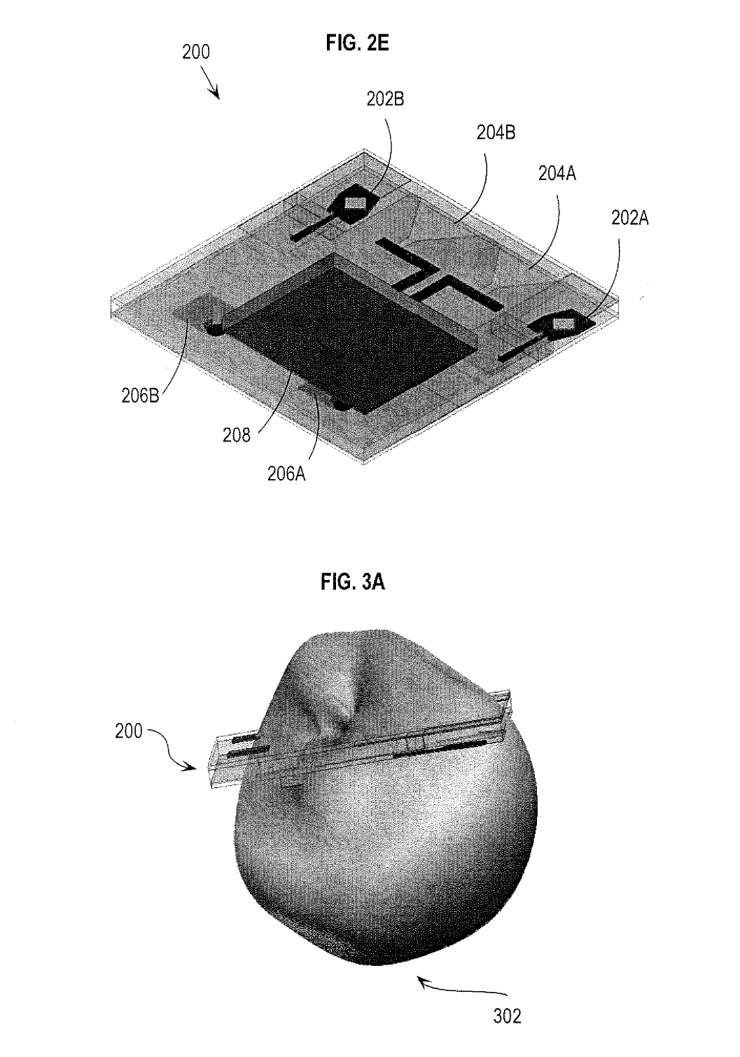

FIG. 2A is a block diagram that depicts an example RFIC antenna package 200 according to an embodiment. In this example, RFIC antenna package 200 includes a plurality of antenna elements 202-206 located and oriented on RFIC antenna package 200 to radiate in different directions, and an RFIC 208 for selecting one or more of the antenna elements 202-206 to be used for wireless communications. RFIC antenna package 200 may include other components and elements, depending upon a particular implementation, and RFIC antenna package 200 is not limited to any particular components or elements. Example implementations for RFIC antenna package 200 include, without limitation, a RF receiver, a RF transmitter, or a RF transceiver.

While some embodiments are described herein in the context of the plurality of antenna elements being located within the antenna package for purposes of explanation, embodiments are not limited to this arrangement and some or all of the antenna elements may be located external to the RFIC antenna package 200. For example, antenna elements 202-206 may be located on a printed circuit board external to RFIC antenna package 200 that includes RFIC 208. In addition, the plurality of antenna elements 202-206 may be any type of directional antenna elements that may vary depending on a particular implementation.

In the example RFIC antenna package 200, antenna elements 202A, 202B are patch antenna elements pointing downward relative to RFIC antenna package 200 and configured to radiate in a substantially downward vertical direction relative to RFIC antenna package 200. Antenna elements 204A, 204B are Vivaldi end fire antenna elements pointing forward relative to RFIC antenna package 200 and configured to radiate in a substantially horizontal direction relative to RFIC antenna package 200. Antenna elements 206A, 206B are other patch antenna elements pointing upward relative to RFIC antenna package 200 and configured to radiate in a substantially upward vertical direction relative to RFIC antenna package 200. For purposes of explanation, the term “horizontal” refers to a plane parallel to RFIC antenna package 200 regardless of the orientation of RFIC antenna package 200. The term “vertical” refers to a plane perpendicular to the horizontal as just defined. Terms, such as “upward”, “downward”, “above”, “below”, “bottom”, “top”, “forward”, “backward”, “left”, and “right” are defined with respect to the horizontal plane.

In the example RFIC antenna package 200, each antenna element 202-206 comprises separate transmit and receive antennas designated as “A” and “B” respectively. However, each of the plurality of antenna elements can include just a receive antenna, just a transmit antenna, separate transmit and receive antennas, or a combined transmit and receive antenna, depending upon a particular implementation.

The plurality of antenna elements 202-206, when driven by RFIC 208, maximally radiate in certain directions. The direction of maximum radiation for an antenna element is a direction in which the antenna element has its highest gain, for example, as measured as decibels over isotropic (dBi). A higher gain antenna generally provides better link budget than a lower gain antenna but suffers from increased directionally relative to the lower gain antenna. At mm-wave frequencies, each of the high-gain directional antenna elements 202-206 may have a gain of approximately 6 dBi and an antenna beam width of approximately seventy (70) degrees, for example. In contrast, each of the low-gain antenna elements used in a beamforming array at mm-wave frequencies may have a gain of approximately 2 dBi and an antenna beam width of approximately 120 degrees, for example.

RFIC antenna package 200 retains the benefits of better link budgets provided by high-gain directional antenna elements 202-206 without suffering the drawbacks of associated increased directionally by switching between the various antenna elements 202-206 to provide the best communication quality under the current communications conditions (e.g., the current physical orientation of RFIC antenna package 200 relative to another mm-wave transceiver).

While in the example RFIC antenna package 200, antenna elements 202A, 202B, 206A, 206B are patch antenna elements and antenna elements 204A, 204B are Vivaldi end fire antenna elements, the antenna elements 202-206 may be other types of antenna elements depending on a particular implementation. For example, each of antenna elements 202-206 may be the same or different one of a monopole antenna, a dipole antenna, a Yagi antenna, a log periodic dipole antenna, a slot antenna, an annular slot antenna, another type of Vivaldi antenna, or an antenna array thereof. Further, the antenna elements that are used are not limited to a particular polarization and each of the antenna elements 202-206 can be linearly, elliptically, or circularly polarized according to a particular implementation. Further still, while six antenna elements are used in the example RFIC antenna package 200, more or fewer antenna elements, and/or different types of antenna elements, may be used in other embodiments to realize antenna radiation coverage in more or fewer directions.

Although not depicted in FIG. 2A, antenna elements 202-206 are connected to RFIC 208 via feed lines. Each feed line may have a specified feed line length. As used herein, the term “feed line length” refers to a length of a feed line from an antenna element to RFIC 208. A feed line length may be determined by the physical characteristics of the electrical connection between an antenna element and RFIC 208, such as dimensional length of the connection and materials used to fabricate the connection. For example, a first antenna element may have a feed line length of 3 millimeters and a second antenna may have a feed line length of 4 millimeters. Alternatively, each of the antenna elements may have the same feed line length. The feed line length may also be affected by surrounding structures and materials. For example, an effective feed line length may be changed by exposing portions of an antenna feed line to a ground plane, e.g., via cutouts or “windows” in an underlying insulating material.

Similarly, to reduce obstruction of the radiation of certain antenna elements pointed toward a ground plane, cutouts or windows may be made in the ground plane. For example, ground plane cutouts or windows may be made for downward pointing antenna element 202. Alternatively, RFIC antenna package 200 (or antenna element 202) may be placed on a printed circuit board of a wireless communications device at a location where the radiation of the antenna element 202 is not obstructed or is only minimally obstructed by a ground plane such as, for example, near or overhanging an edge of the printed circuit board.

FIGS. 2A-2D depict schematic views of an example embodiment of RFIC antenna package 200 of FIG. 2A. In particular, FIG. 2B is a top schematic view, FIG. 2C is a bottom schematic view, FIG. 2D is a top perspective schematic view, and FIG. 2E is a bottom perspective schematic view of RFIC antenna package 200 of FIG. 2A. As depicted in FIGS. 2A-2D, substantially square window cutouts of the ground plane may be provided to reduce obstruction of the radiation from downward pointing antenna element 202.

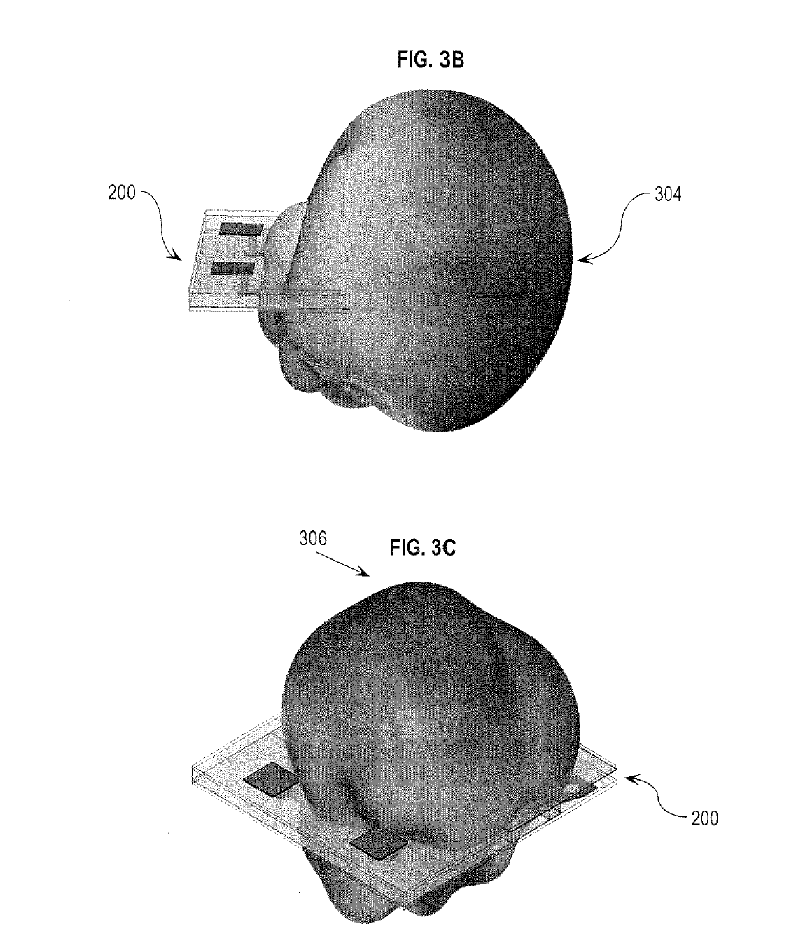

FIGS. 3A-3C depict example three-dimensional radiation pattern plots of antenna elements 202-206 of RFIC antenna package 200 of FIG. 2A, respectively. In particular, FIG. 3A is an example three-dimensional radiation pattern plot 302 when one or both of the downward pointing patch antenna elements 202A, 202B are being driven and the other antenna elements 204, 206 are not being driven. In this example, the downward pointing patch antenna elements 202A, 202B radiate in a substantially downward vertical direction relative to RFIC antenna package 200. FIG. 3B is an example three-dimensional radiation pattern plot 304 when one or both of the forward pointing end fire antenna elements 204A, 204B are being driven and the other antenna elements 202A, 202B, 206A, 206B are not being driven. In this example, the forward pointing end fire antenna elements 204A, 204B radiate in a substantially forward horizontal direction relative to RFIC antenna package 200. FIG. 3C is an example three-dimensional radiation pattern plot 306 when one or more of the upward pointing patch antenna elements 206A, 206B are being driven and the other antenna elements 202A, 202B, 204A, 204B are not being driven. In this example, the upward pointing patch antenna elements 206A, 206B radiate in a substantially upward vertical direction relative to RFIC antenna package 200. Thus, depending on which antenna element 202-206 is selected for use and being driven, RFIC antenna package 200 can be used for mm-wave frequency band communications with another mm-wave transceiver in at least three different directions.

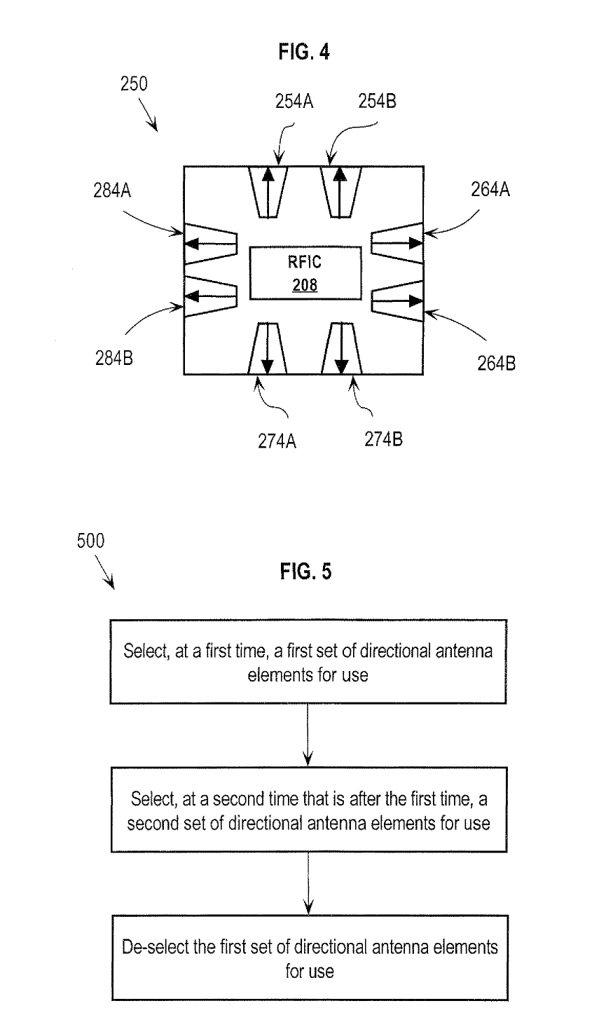

FIG. 4 is a block diagram that depicts an embodiment of an RFIC antenna package 250 that includes only Vivaldi end fire antenna elements 254A, 254B, 264A, 264B, 274A, 274B, 284A, 284B and RFIC 208. The Vivaldi end fire antenna elements 254A, 254B, 264A, 264B, 274A, 274B, 284A, 284B are each configured to radiate in substantially horizontal directions. In particular, end fire antenna elements 254A, 254B, like end fire antenna elements 204A, 204B of RFIC antenna package 200, are configured to radiate in a substantially forward direction. End fire antenna elements 264A, 264B are configured to radiate substantially right, end fire antenna elements 284A, 284B substantially left, and end fire antenna elements 274A, 274B in a substantially backward direction. The antenna element configuration of RFIC antenna package 250 may be appropriate for certain types of wireless communications devices such as, for example, devices that are typically physically oriented horizontally such as when lying flat on a table or other horizontal surface.

### IV. Antenna Selection

According to one embodiment, directional antenna elements on mobile devices are selected for use and/or de-selected for use to achieve a desired radiation pattern, shape, and/or direction. As used herein, the term “selected for use” refers to selecting an antenna element to be used for transmission and/or reception of electromagnetic radiation and the term “de-selected for use” refers to selecting an antenna element to not be used for transmission and/or reception of electromagnetic radiation. For example, selecting an antenna element for use may include activating a power amplifier that drives the selected antenna element and de-selecting for use may include de-activating a power amplifier that drives the de-selected antenna element.

Antenna element selection may be accomplished using a wide variety of techniques that may vary depending upon a particular architecture and implementation. For example, RFIC 208 may be configured to use low noise amplifier (LNA) bank outputs to select and de-select corresponding receiving antenna elements. RFIC 208 may be configured with hardware and/or software interfaces, e.g., application program interfaces (APIs), to allow other components and software processes, either within or external to the antenna apparatus, to issue commands to RFIC 208 to select and de-select antenna elements for use. For example, participant devices in communication with the antenna apparatus may issue commands to RFIC 208 to select and de-select antenna elements for use.

In some implementations, if an antenna is a transmit antenna, then the antenna may be connected to a power amplifier of RFIC 208, and/or if the antenna is a receive antenna, then the antenna may be connected to a low noise amplifier of RFIC 208. In these implementations, RFIC 208 can select and de-select an antenna for use in several different ways. For example, RFIC 208 can turn the biasing (power supply) on for a given low noise amplifier to select a corresponding antenna for use, and RFIC 208 can turn the biasing off for the low noise amplifier to de-select the antenna for use. Similarly, RFIC 208 can turn the biasing on for a given power amplifier to select a corresponding antenna for use, and RFIC 208 can turn the biasing off for the power amplifier to de-select the antenna for use. As another example, a switch circuit may be placed on RFIC 208 between the low noise amplifier and the power amplifier corresponding to an antenna. In this implementation, the switch circuit may be used to select and de-select the antenna for use without manipulating the biasing of the low noise amplifier or the power amplifier.

FIG. 5 is a flow diagram 500 that depicts an approach for a mobile device to select different antenna elements for use, according to an embodiment. In step 402, at a first time, a first set of one or more directional antenna elements is selected for use. For example, RFIC 208 of RFIC antenna package 200 may select for use antenna element 202A and optionally de-select for use antenna elements 202B, 204A, 204B, 206A, 206B, depending upon whether antenna elements 202B, 204A, 204B, 206A, 206B were previously selected for use. The radiation pattern of the first set of one or more directional antenna elements predominately radiates in a particular direction and with a particular beam width. For example, the first set of one or more directional antenna elements may radiate in a predominately downward vertical direction with an approximately seventy (70) degree beam width, as depicted in FIG. 3A.

In step 504, at a second time that is after the first time, a second set of one or more directional antenna elements is selected for use. For example, RFIC 208 may select for use antenna element 204A and de-select for use antenna element 202A. Since antenna elements 202B, 204B, 206A, 206B was previously de-selected for use, a command does not necessarily need to be issued to de-select for use antenna elements 202B, 204B, 206A, 206B. Whether optional commands are issued may depend upon a particular implementation. For example, in some implementations, a command may be issued to select for use or de-select for use a particular antenna element, regardless of whether the particular antenna element is already selected for use or de-selected for use. The radiation pattern of the second set of one or more directional antenna elements predominately radiates in a particular direction and with a particular beam width. For example, the second antenna element may radiate in a predominately forward horizontal direction with an approximately seventy (70) degree beam width, as depicted in FIG. 3B.

In step 506, at a third time that is after the second time, a third set of one or more directional antenna elements is selected for use. For example, RFIC 208 of RFIC antenna package 200 may select for use antenna element 206A and optionally de-select for use antenna element 204A. The radiation pattern of the third set of one or more directional antenna elements predominately radiates in a particular direction and with a particular beam width. For example, the third set of one or more directional antenna elements may radiate in a predominately upward vertical direction with an approximately seventy (70) degree beam width, as depicted in FIG. 3C.

Not all of these steps 502, 504, and 506 are required and additional steps may be performed, depending upon a particular implementation. As one example, steps 504 and 506 may be optional in that only one of the antenna elements may be used for an entire communications session. Further, antenna elements may be re-selected for use after previously being selected for use. For example, in step 506, instead of selecting a third set of one or more directional antenna elements for use, the first set of one or more directional antenna elements selected in step 502 may be re-selected for use. This approach allows a mobile device to conduct Wi-Gig wireless communications with other devices without the use of beam forming, which allows for a smaller and less complex implementation that consumes less power compared to wireless devices that implement beam forming.

Antenna element switching as described herein may be employed at any time during communications, for example, during initialization of a communications system, or during active communications sessions. In addition, after an initial set of one or more antenna elements has been selected, a different set of one or more antenna elements may be selected at any time for use in place of the initial set of one or more antenna elements, for example, to accommodate a change in position of communication participants. For example, at a first time, a first antenna element may be selected for communications between a first participant and a second participant, and at a second time that is different than the first time, a second antenna element that is different than the first antenna element may be selected for communications between the first participant and the second participant.

Antenna elements may be selected based upon the particular participants participating in communications. For example, a first antenna element may be selected for communications between a first participant and a second participant and a second antenna element may be selected for communications between the first participant and a third participant, where the second and third participants are different participants. An antenna element may be selected based upon whether a device is transmitting or receiving signals. For example, a first antenna element may be selected for transmission and a different antenna element may be selected for reception.

Embodiments are described herein in the context of three and four antenna elements for purposes of explanation only and embodiments are applicable to antenna arrangements using any number of antenna elements. Antenna arrangements with a greater number of antenna elements may be used to increase the directionality of the apparatus or optimize for certain directions. For example, RFIC antenna package 200 includes three antenna elements 202-206 for optimizing RF communications with another wireless communications device in the upward, downward, and forward directions while RFIC antenna package 250 includes four antenna elements 254A/B, 264A/B, 274A/B, 284A/B for optimizing RF communications in the forward, backward, left, and right directions.

A wide variety of selection criteria may be used to select for use a particular antenna, or a set of two or more particular antennas. Example selection criteria include, without limitation, power consumption, performance criteria and interference avoidance criteria. Selection criteria may be weighted to change the influence that particular selection criteria have on a selection of one or more antennas for use. For example, a first selection criterion may be assigned a higher weight than a second selection criterion to increase the influence on an antenna selection attributable to the first selection criterion relative to the second selection criterion. Thresholds may also be used to ensure that a selection of one or more antennas satisfies the selection criteria used. For example, power consumption and performance selection criteria may be used to select for use one or more antennas that consume the least amount of power while still satisfying a minimum performance threshold. Different selection criteria may be used for different mobile devices depending, for example, on the type of mobile device and/or the importance of power conservation. Selection criteria may be changed over time. For example, a particular mobile device may be configured with initial selection criteria specified by a manufacturer or an administrator and the initial selection criteria may then be changed at a later time. Location may also be used as a selection criterion. For example, the known position of a base station, e.g., via global positional satellite (GPS) coordinates, relative to a mobile device, may be used to select one or more antennas to be used for communications.

According to one embodiment, a mobile device is configured to select for use a single directional antenna for communication with another device to reduce power consumption. The selection may be specific to the other device. For example, referring to FIG. 1B, mobile device 104 may select for use a first directional antenna that provides communications with base station 102 via coverage area 110a. Mobile device 104 may then select for use a second directional antenna that provides communications with mobile device 106 via coverage area 110b. When communicating with mobile device 106, mobile device 104 may de-select for use the first directional antenna so that only the second directional antenna is active to reduce power consumption. Thus, in this example, mobile device 104 switches from using the first directional antenna to using the second directional antenna to reduce power consumption while still providing an acceptable level of performance and/or interference avoidance.

The selection of directional antenna elements may be made at any time that may vary depending upon a particular implementation. When mobile device 104 is first powered on, or when communications with other devices are to be initiated, mobile device 104 may use a default configuration that specifies one or more particular directional antenna elements to be used for communications. The default configuration may be general, or may be specific to a particular device. For example, a default configuration may specify that a set of one or more directional antenna elements are to be used in all situations, regardless of the other devices that might in communications. As another example, when it is known that communications will be conducted with a particular device, such as base station 102, then the default configuration may specify that a particular directional antenna, or antennas, are to be used. One or more antennas selected for use in accordance with a default configuration may be changed at any time. For example, a first directional antenna may be selected for use in accordance with a default configuration and then a second directional antenna may be immediately, or later, selected for use instead of the first directional antenna. This may be done to provide lower power consumption and better performance and/or interference avoidance. Further directional antenna selections may be made at any time.

According to one embodiment, scanning is used to evaluate the performance of each of a plurality of directional antenna elements and the directional antenna providing the lowest power consumption and the best performance and/or interference avoidance is selected for use. Scanning may include using each of the available directional antenna elements one at a time, or scanning may include using more than one of the available directional antenna elements at a time. Antenna performance may be measured according to a wide variety of criteria that may vary depending upon a particular implementation. For example, error rates, e.g., packet error rates, and/or signal-to-noise ratios may be used to evaluate antenna performance. Scanning may be useful, for example, to identify one or more antennas that are currently blocked and therefore should not be used for communications at the current time. Once the performance of the available directional antenna elements has been determined, then one or more directional antenna elements may be selected for use. According to one embodiment, the one or more directional antenna elements selected for use consume the least amount of power among the available directional antenna elements, while still satisfying any applicable performance and/or interference avoidance criteria.

According to one embodiment, mobile devices may be configured to select directional antenna elements for use according to an operating mode. One example mode is a low power mode in which a single directional antenna is selected as previously described herein. The low power mode may be used, for example, to transfer video or audio data between communications devices. Another example mode is a coverage mode in which multiple directional antenna elements are used. The coverage mode may be used, for example, to transfer data files between communications devices. Similarly, in an accuracy mode, multiple directional antenna elements are used with intelligent beam forming to provide better coverage.

The approaches described herein may be selectively implemented on particular devices. For example, the approaches may be implemented on mobile devices, such as mobile devices 104, 106, where lower power consumption is desirable, but not implemented on devices, such as base station 102, where power consumption attributable to multiple active antenna elements is not a concern. As another example, the approaches may be implemented on mobile device 104, but not mobile device 106. The use of the approaches described herein may be determined, for example, based upon a configuration of a mobile device, or the use may be selectable by a user, for example, via an application on the mobile device.

In the foregoing specification, embodiments are described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A mobile device comprising:
a plurality of directional antenna elements, wherein at least two directional antenna elements from the plurality of directional antenna elements are configured to radiate in different directions; and
a radio frequency integrated circuit configured to select for use, by the mobile device, a first set of one or more directional antenna elements from the plurality of directional antenna elements based upon selection criteria that include at least one or more power consumption criteria and one or more of one or more performance criteria or one or more interference avoidance criteria.

2. The mobile device of claim 1, wherein:
the first set of one or more directional antenna elements includes a single directional antenna, and
the mobile device consumes less power when using the single directional antenna element relative to using two or more other directional antenna elements from the plurality of directional antenna elements.

3. The mobile device of claim 1, wherein the radio frequency integrated circuit is configured to performing testing to evaluate one or more of performance or interference avoidance when one or more directional antenna elements from the plurality of directional antenna elements are used.

4. The mobile device of claim 1, wherein the first set of one or more directional antenna elements from the plurality of directional antenna elements is different than a default set of one or more directional antenna elements from the plurality of directional antenna elements that is used at startup of the mobile device.

5. The mobile device of claim 1, wherein:
the selection for use by the mobile device of the first set of one or more directional antenna elements from the plurality of directional antenna elements is performed at a first time, and
the radio frequency integrated circuit is further configured to, at a second time that is later than the first time:
select for use by the mobile device, a second set of one or more directional antenna elements from the plurality of directional antenna elements, wherein the second set of one or more directional antenna elements is different than the first set of directional antenna elements from the plurality of directional antenna elements, and
de-select for use by the mobile device the first set of one or more directional antenna elements.

6. The mobile device of claim 1, wherein:
the selection for use by the mobile device of the first set of one or more directional antenna elements from the plurality of directional antenna elements is performed at a first time and for communication with a second device that is different than the mobile device, and
the radio frequency integrated circuit is further configured to, at a second time that is later than the first time:
select for use by the mobile device, a second set of one or more directional antenna elements from the plurality of directional antenna elements for communication with a third device, wherein the second set of one or more directional antenna elements is different than the first set of directional antenna elements from the plurality of directional antenna elements and the third device is different than the mobile device and the second device, and
de-select for use by the mobile device the first set of one or more directional antenna elements.

7. The mobile device of claim 1, wherein the plurality of directional antenna elements includes a first directional antenna element that is a patch antenna and a second directional antenna element that is an end fire antenna.

8. The mobile device of claim 1, wherein a first directional antenna element from the at least two directional antenna elements is located in the mobile device to radiate from a first side of the mobile device and a second directional antenna element from the at least two directional antenna elements is located in the mobile device to radiate from a second side of the mobile device that is different than the first side of the mobile device.

9. The mobile device of claim 8, wherein the first directional antenna element radiates in a substantially horizontal direction relative to the mobile device and the second directional antenna element radiates in a substantially vertical direction relative to the mobile device.

10. The mobile device of claim 8, wherein the first directional antenna element and the second directional antenna element each include separate receive and transmit antennas.

11. The mobile device of claim 1, wherein:
the one or more power consumption criteria include a power consumption threshold, and
the mobile device consumes less than the power consumption threshold of power when using the first set of one or more directional antenna elements.

12. A method performed by a mobile device comprising a plurality of directional antenna elements and a radio frequency integrated circuit (RFIC), the method comprising:
selecting, at a first time, based upon selection criteria that include at least one or more power consumption criteria and one or more of one or more performance criteria or one or more interference avoidance criteria, a first antenna element from the plurality of antenna elements to use for radio frequency (RF) communications with a first wireless communications device; and
selecting, at a second time that is after the first time, based upon the selection criteria that include at least one or more power consumption criteria and one or more of one or more performance criteria or one or more interference avoidance criteria, a second antenna element from the plurality of antenna elements to use for RF communications with a second wireless communications device that is different than the first wireless communications device, and de-selecting the first antenna element to use for RF communications with the first wireless communications device;
wherein the second antenna element is different than the first antenna element and the second antenna element radiates in a different direction than the first antenna element.

13. The method of claim 12, wherein the radio frequency integrated circuit is configured to performing testing to evaluate one or more of performance or interference avoidance when one or more directional antenna elements from the plurality of directional antenna elements are used.

14. The method of claim 12, wherein the first directional antenna element is specified by a default configuration and the second antenna element is not specified by the default configuration.

15. The method of claim 12, wherein the first directional antenna element is a patch antenna and the second directional antenna element is an end fire antenna.

16. The method device of claim 12, wherein the first directional antenna element is located in the mobile device to radiate from a first side of the mobile device and the second directional antenna element is located in the mobile device to radiate from a second side of the mobile device that is different than the first side of the mobile device.

17. The method of claim 16, wherein the first directional antenna element radiates in a substantially horizontal direction relative to the mobile device and the second directional antenna element radiates in a substantially vertical direction relative to the mobile device.

18. An apparatus comprising:
a first wireless communications device comprising a plurality of antenna elements and a beam forming component configured to select for simultaneous use, two or more antenna elements from the plurality of antenna elements; and
a mobile device comprising:
a plurality of directional antenna elements, wherein at least two directional antenna elements from the plurality of directional antenna elements are configured to radiate in different directions, and
a radio frequency integrated circuit configured to:
at a first time select, based upon selection criteria that include at least one or more power consumption criteria and one or more of one or more performance criteria or one or more interference avoidance criteria, a first directional antenna element from the plurality of directional antenna elements to use for radio frequency (RF) communications with the first wireless communications device,
at a second time that is after the first time select, based upon the selection criteria that include at least one or more power consumption criteria and one or more of one or more performance criteria or one or more interference avoidance criteria, a second directional antenna element from the plurality of directional antenna elements to use for RF communications with the first wireless communications device, and
at the second time de-select for use the first directional antenna element;
wherein the second directional antenna element is different than the first directional antenna element and the second directional antenna element radiates in a different direction than the first directional antenna element.

19. The apparatus of claim 18, wherein the radio frequency integrated circuit is further configured to:
at a third time that is after the second time select, based upon the selection criteria that include at least one or more power consumption criteria and one or more of one or more performance criteria or one or more interference avoidance criteria, a third directional antenna element from the plurality of directional antenna elements to use for RF communications with a second wireless communications device that is different than the mobile device and the first wireless communications device, and
at the third time de-select for use the second directional antenna element.

20. The apparatus of claim 18, wherein the first directional antenna element is a patch antenna and the second directional antenna element is an end fire antenna.
